(19) United States
(12) Patent Application Publication
(10) Pub. No.: US 2016/0179626 A1
(43) Pub. Date: Jun. 23, 2016

(54) COMPUTER SYSTEM, ADAPTABLE HIBERNATION CONTROL MODULE AND CONTROL METHOD THEREOF

(71) Applicant: SHUTTLE INC., Taipei City (TW)

(72) Inventor: Chia-Ching LIN, Taipei City (TW)

(21) Appl. No.: 14/677,406

(22) Filed: Apr. 2, 2015

(30) Foreign Application Priority Data
Dec. 19, 2014 (TW) 103144471

(51) Int. Cl. G06F 11/14; G06F 9/44

(52) U.S. Cl. CPC G06F 11/1451; G06F 11/1435; G06F 9/442; G06F 2201/84

(57) ABSTRACT

A computer system comprising a CPU, a coprocessor and a JTAG connection port connected with the CPU and the coprocessor is presented. When receiving a hibernation trigger signal, the coprocessor executes a hibernation procedure to backup a current state of the computer system and shut down the computer system. When receiving an awaking trigger signal, the coprocessor executes an awaking procedure to make the current status of the computer system recover to the state anterior to the execution of the hibernation procedure according to an awaking data corresponding to the CPU of the computer system.

### BACKGROUND OF THE INVENTION

1. Field of the Invention

The technical field relates to computer system, control module and control method and more particularly related to computer system, adaptable hibernation control module and adaptable hibernation control method comprising a function of adaptable hibernation control.

2. Description of Related Art

The ACPI (Advanced Configuration and Power Interface) standard is the most common power management specification. Via the ACPI standard, the R&D (Research and Development) personnel can conveniently manage the power system of the computer system.

In the ACPI standard, the sleeping statuses (S-States) of the computer system comprises six modes which are respectively S0 mode, S1 mode, S2 mode, S3 mode, S4 mode or S5 mode. Following description is used to explain three most common modes of the sleeping statuses: S0 mode, S3 mode and S4 mode.

At the S0 mode, the status of the computer system is that has been booted and normally operates.

The S3 mode is known as the standby mode or the STR (Suspend to RAM) mode. At the standby mode, a computer system only provides the power to a main memory, and stops providing power to the other devices for power-saving. When the computer system leaves the standby mode, because the main memory still has stored all status data anterior to the execution of the standby mode, the computer system can directly operate and achieve the fast booting function to recover to the status anterior to the execution of the standby mode without reloading the various software (such as driver or operating system (OS)) or re-executing the initialization.

More specifically, because the main memory is a volatile memory, the computer system must continuously provide the power to the main memory after enter the standby mode. Once the main memory is de-energized, all data stored in the main memory will disappear. Above situation will make the computer system fail to achieve the fast booting function after leave the standby mode and fail to recover to the status anterior to the execution of the standby mode.

The S4 mode is known as the hibernation mode or the STD (Suspend to Disk) mode. Please refer to FIG. 1A and FIG. 1B, which are respectively a first schematic view of a hibernation mode according to the related art and a second schematic view of a hibernation mode according to the related art. FIG. 1A and FIG. 1B are used to explain the operation ways about how the computer system of the related art enters to the hibernation mode or leaves the hibernation mode.

As shown in FIG. 1A, the computer system of the related art comprises a Central Processing Unit (CPU) 10, a main memory 12 and a hard disk 14. The main memory 12 stores a status data 120 corresponding to a current status of the related-art computer system 1.

The hard disk 14 stores a hibernation program 140. The hibernation program 140 is dedicated for the specific CPU 10. More specifically, the hibernation program 140 is part of the operating system (OS) or the boot loader of the related-art computer system 1.

When the CPU 10 receives a hibernation trigger signal, the CPU 10 can execute the hibernation program 140 to make the related-art computer system 1 enter the hibernation mode. More specifically, after the CPU 10 executes the hibernation program 140, the CPU 10 can back up the status data 120 to the hard disk 14 as a backup status data 120′, and can stop providing the power to all devices (comprising the main memory 12) of the related-art computer system 1 for power-saving.

When the CPU 10 having entered the hibernation mode receives an awaking trigger signal, the CPU 10 can execute the hibernation program 140 to leave the hibernation program. More specifically, after the CPU 10 is awaked and executes the hibernation program 140, the CPU 10 can load the backup status data 120′ from the hard disk 14 to the main memory 12 as the status data 120 as shown in FIG. 1B, and can re-start up the other devices.

Thus, the related-art computer system 1 can achieve the fast booting function, and can fast recover the current status to the status anterior to the execution of the hibernation procedure via the backup status data 120′ after being awaked. Additionally, because the related-art computer system stops providing the power to all devices at the hibernation mode, the hibernation mode is the most power-saving mode of the sleeping states.

However, because the hibernation program 140 is dedicated for the specific CPU 10. When the manufacturer of the related-art computer system 1 wants to launch another new computer system 1 using a new CPU (In other words, the type of the new CPU is different from the type of the original CPU 10.), the R&D personnel of the manufacturer must significantly modify the hibernation program 140 to make the hibernation program 140 applicable to the new CPU. Additionally, because the hibernation program 140 is part of the OS or the boot loader, the difficulty and the complexity of aforementioned modifying the hibernation program 140 are increased.

Therefore, there is a need to find out a better and more effective solution to handle such problems.

### SUMMARY OF THE INVENTION

The object of the disclosed example is to provide a computer system, an adaptable hibernation control module and an adaptable hibernation control method which are applicable to the CPUs respectively having the different types.

One of the exemplary embodiments, a computer system, comprising: a JTAG (Joint Test Action Group) connection port; a CPU electrically connected to the JTAG connection port; and a coprocessor connected to the JTAG connection port comprising an awaking data corresponding to the CPU; wherein the coprocessor sends a hibernation control signal to the CPU to execute a hibernation procedure via controlling the CPU when receive a hibernation trigger signal; the hibernation procedure comprises backing up a current status data of the computer system and shutting down the computer system; the coprocessor sends an awaking control signal and an awaking data to the CPU to execute an awaking procedure according to the awaking data via controlling the CPU when receive an awaking trigger signal; the awaking procedure comprises making the current status of the computer system recover to a status anterior to the execution of the hibernation procedure.

One of the exemplary embodiments, an adaptable hibernation control module, comprising: an auxiliary connection port connected to a JTAG connection port of a computer system via a JTAG connection component, wherein the JTAG connection port is electrically connected to a CPU of the computer system; and a coprocessor electrically connected to the auxiliary connection port comprising an awaking data corresponding to the CPU; wherein the coprocessor sends a hibernation control signal to the CPU to execute a hibernation procedure via controlling the CPU when receive a hibernation trigger signal; the hibernation procedure comprises backing up a current status data of the computer system and shutting down the computer system; the coprocessor sends an awaking control signal and an awaking data to the CPU to execute an awaking procedure according to the awaking data via controlling the CPU when receive an awaking trigger signal; the awaking data procedure comprises making the current status of the computer system recover to a status anterior to the execution of the hibernation procedure.

One of the exemplary embodiments, an adaptable hibernation control method, comprising: a) a coprocessor sending a hibernation control signal to a CPU of a computer system to execute a hibernation procedure via controlling the CPU when receive a hibernation trigger signal; b) the CPU backing up a current status of the computer system and shutting down the computer system according to the hibernation control signal; c) the coprocessor retrieving an awaking data corresponding to the CPU of the computer system when receive an awaking trigger signal; d) sending an awaking control signal and the retrieved awaking data to the CPU to execute an awaking procedure according to the awaking data via controlling the CPU; e) the CPU making the current status of the computer system recover to a status anterior to the execution of the hibernation procedure.

This present disclosed example can lead the computer systems which respectively installed the various CPUs to achieve the fast booting function without modifying the OS or the boot loader of the computer system via using the coprocessor to replace the CPU to execute the hibernation procedure and the awaking procedure.

### BRIEF DESCRIPTION OF DRAWING

FIG. 1A is a first schematic view of a hibernation mode according to the related art.

FIG. 1B is a second schematic view of a hibernation mode according to the related art.

FIG. 2 is an architecture diagram of a computer system according to a first embodiment of the present disclosed example;

FIG. 3 is a schematic view of a computer system according to a first embodiment of the present disclosed example;

FIG. 4 is an architecture diagram of an adaptable hibernation control module according to a first embodiment of the present disclosed example;

FIG. 5 is a schematic view of an adaptable hibernation control module according to a first embodiment of the present disclosed example;

FIG. 6 is a flowchart of an adaptable hibernation control method according to a first embodiment of the present disclosed example;

FIG. 7 is a flowchart of an adaptable hibernation control method according to a second embodiment of the present disclosed example.

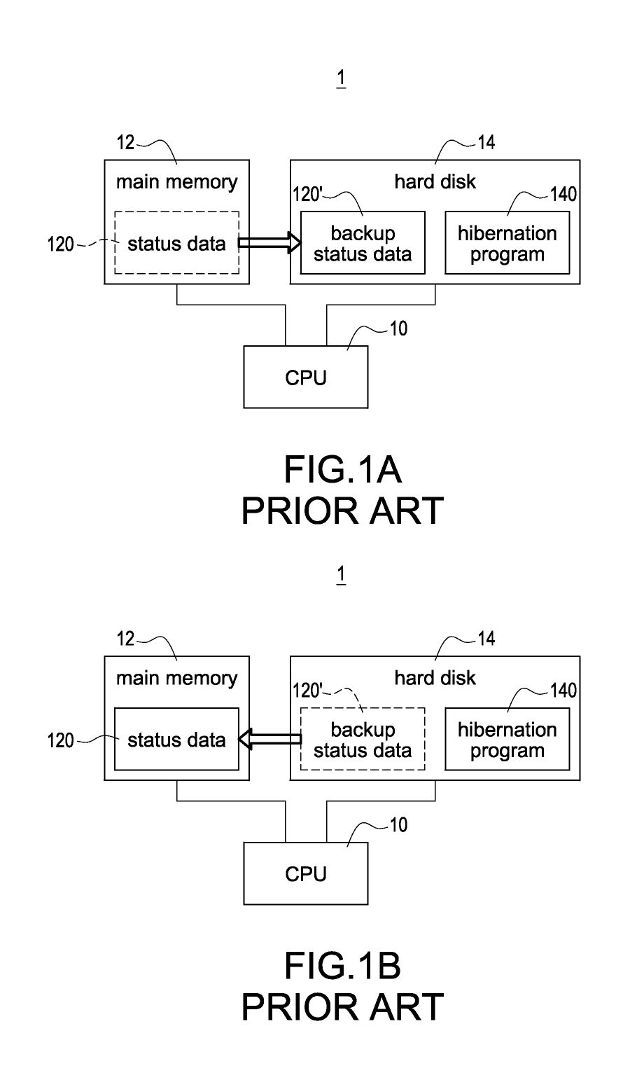

### DETAILED DESCRIPTION OF THE INVENTION

In cooperation with the attached drawings, the technical contents and detailed description of the present invention are described thereinafter according to a preferable embodiment, being not used to limit its executing scope. Any equivalent variation and modification made according to appended claims is all covered by the claims claimed by the present invention.

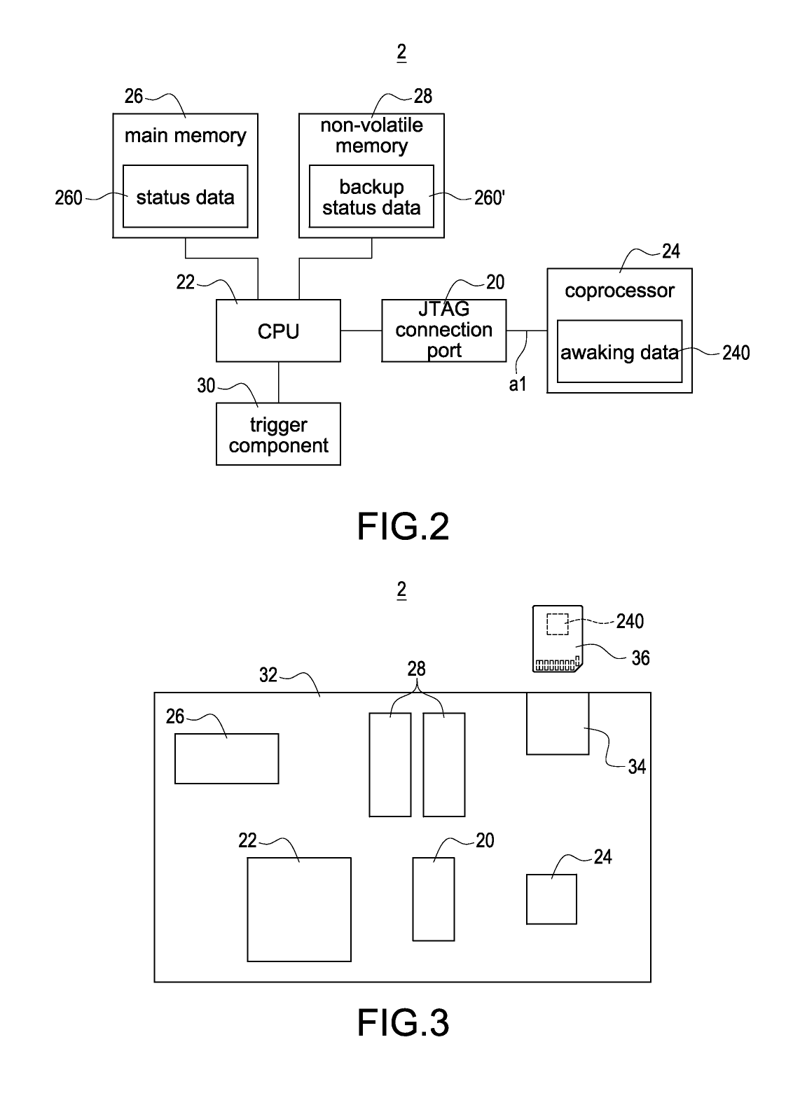

First, please refer to FIG. 2, which illustrates an architecture diagram of a computer system according to a first embodiment of the present disclosed example. As shown in FIG. 2, the computer system 2 comprising an adaptable hibernation control function (hereinafter referred to the computer system 2) mainly comprises a JTAG connection port 20, a CPU 22 and a coprocessor 24.

The JTAG connection port 20 is used to transfer the commands or the data. More specifically, the JTAG connection port 20 is a connection port supporting the Joint Test Action Group (JTAG) interface technology.

Please be noted that the JTAG interface technology is a technology developed based on IEEE-1149.1 Boundary Scan Architecture. About the application of the JTAG interface technology, the JTAG interface is an interface specifically used for burning or testing a Printed Circuit Board (PCB) (such as the PCB 32 shown in FIG. 3).

For example, if the R&D personnel want to debug each function of the computer system 2 in the development stage, the R&D personnel can connect an In-Circuit Emulator (ICE) to the JTAG connection port 20. Then, the R&D personnel can operate the ICE to send a specific control signal to the computer system 2, and can observe whether any error occurs or the error is fixed during the computer system 2 operating according to the received control signal. As a result, the R&D personnel can conveniently input various control signals to the computer system 2 to emulate various statuses for detecting the error or debugging via the JTAG interface technology.

Preferably, the control signal comprises an address field and a command field. The address field is corresponded to a hardware address of a device that the R&D personnel wants to control. The hardware address is used to indicate the device that the CPU 22 wants to control. The command field is used to indicate the content of the control operation (such as stopping providing the power, providing the power, reading the data or writing the data).

Because of above advantages, the computer system can configure the JTAG connection port 20 to make the R&D personnel conveniently detect the error or debug in the development stage.

The CPU 22 is electrically connected to the JTAG connection port 20. The CPU 22 can control the operation of each component of the computer system 2 (such as power on/off or mouse enable/disable). The CPU 22 can receive the control signal via the JTAG connection port 20, and can perform an operation corresponding to the control signal. Preferably, the CPU 22 supports the JTAG technology.

For example, if the control signal is a shutdown signal, the CPU 22 can shut down all devices (comprising the CPU 22) of the computer system 2 to make the computer system 2 enter the shutdown status.

The coprocessor 24 is connected to the JTAG connection port 20. More specifically, the coprocessor 24 is connected to the JTAG connection port 20 via a JTAG connection component a1. The JTAG connection port 20 is connected to one end of the JTAG connection component a1, and the coprocessor 24 is connected to another end of the JTAG connection component a1. Preferably, the JTAG connection component a1 is a bus or the conductive wires printed on the PCB 32, but this specific example is not intended to limit the scope of the disclosed example.

The coprocessor 24 can send the control signal to the CPU 22 to control the CPU 22 via the JTAG connection component al and the JTAG connection port 20, and can control the computer system 2 via controlling the CPU 22.

Following description is used to explain how to control the computer system 2 to enter the hibernation mode. When the coprocessor 24 receives a hibernation trigger signal, the coprocessor 24 can send a hibernation control signal corresponding to the hibernation trigger signal to the CPU 22 to control the CPU 22. In this embodiment of the disclosed example, the coprocessor 24 executes a hibernation procedure via sending the hibernation control signals. The hibernation procedure comprises an operation of backing up the current status of the computer system 2 via controlling the CPU 22 and an operation of shutting down the computer system 2 to make the computer system 2 enter the hibernation mode.

More specifically, the computer system 2 further comprises a main memory 26 (such as Random Access Memory (RAM)) and a non-volatile memory 28 (such as Hard Disk Drive (HDD), flash memory or Solid State Drive (SSD)). The main memory 26 electrically connected the CPU 22 is used to temporarily store a status data 260 which is used to represent the current status (such as the current active applications or windows or the current configuration parameters of the system) of the computer system 2, and is stored in an access data address of the main memory 26.

When the coprocessor 24 executes the hibernation procedure, the coprocessor 24 controls the CPU 22 to back up the status data 260 from the access data address of the main memory 26 to a mapping address of the non-volatile memory 28, wherein the mapping address is corresponded to the access data address. Thus, the non-volatile memory 28 can store a backup status data 260′ to avoid the unavailability (or loss) of the status data 260 caused by the powered-off main memory. Besides, when the computer system 2 enters the hibernation mode (In other words, the coprocessor 24 successfully executes the hibernation procedure.), the computer system 2 can completely shut down, and the computer system 2 doesn't need to provide the power to the main memory 26.

Following description is used to explain how to control the computer system 2 to leave the hibernation mode. When the coprocessor 24 receives an awaking trigger signal, the coprocessor 24 can first retrieve an awaking data 240 corresponding to the CPU 22, and can send an awaking control signal to the CPU 22 to control the CPU 22 according to the awaking data 240. In this embodiment of the disclosed example, the coprocessor 24 executes an awaking procedure via sending the awaking control signal. The awaking procedure comprises an operation of starting up the computer system 2 via controlling the CPU 22 and an operation of recovering the current status of the computer system 2 to a status anterior to the execution of the hibernation procedure.

More specifically, the awaking data 240 can be stored in a memory of the coprocessor 24, the non-volatile memory 28 or an external memory connected to the CPU 22. If the computer system 2 is such configured that the awaking data is stored in the memory of the coprocessor 24, because the R&D personnel doesn't have to consider the problem of access between the different file system (namely, the non-volatile memory 28 and the coprocessor 24 may respectively use the different file system standards), the development time can be effectively shortened. In this embodiment of the disclosed example, the awaking data 240 mainly comprises a register data address corresponding to the CPU 22, the access data address and the mapping address. Preferably, the register data address is pre-configured by the R&D personnel according to the type of the CPU 22. The access data address is the memory address of the main memory 26 that is retrieved by the coprocessor 24 for storing the status data 250 when the coprocessor 24 executes the hibernation procedure. The mapping address is the memory address of the non-volatile memory 28 that is pre-configured by the R&D personnel for storing the backup status data 260′. But this specific example is not intended to limit the scope of the disclosed example.

After the coprocessor 24 retrieves the awaking data 240, the coprocessor 24 send the awaking control signal to the CPU 22 to execute the awaking procedure according to the awaking data 240. Via the execution of the awaking procedure, the coprocessor 24 can transfer the register data address to the CPU 22 to make the CPU 22 operate according to the received register data address.

More specifically, the CPU 22 comprises a plurality of registers. Each register is respectively corresponding to one register data address. The CPU 22 executes the access control to the plurality of registers for executing various operations or procedures according to the plurality of register data addresses.

Thus, in this embodiment of the disclosed example, after the CPU 22 receives the awaking control signal and the awaking data, the CPU 22 could be enabled. The CPU 22 can execute the access control to the plurality of registers according to the received register data address, and can execute the corresponded control according to the awaking control signal (such as controlling the other devices of the computer system 2 to resume operation).

After the CPU 22 recovers to normally operate according to the received awaking control data and the received register data address, the CPU 22 can further read the backup status data 260′ and load the backup status data 260′ to the access data address of the main memory 26 for recovering the status data 260 according to the awaking control signal, the access data address and the mapping address. Thus, the coprocessor 24 can make the CPU 22 fast recover to normally operate via the awaking data 240, and can make the computer system 2 achieve both the fast booting function and the hibernation control function.

For example, when the manufacturer of the computer system 2 wants to replace the CPU 22 (namely, the first CPU) of the computer system 2 with another CPU (namely, the second CPU) having the different type from the first CPU to use the computer system 2 as the new product, the R&D personnel of the manufacturer only needs to modify the awaking data (such as replacing the register data address corresponding to the first CPU with the register data address corresponding to the second CPU). Via the coprocessor 24, the computer system installed the second CPU can achieve both the fast booting function and the hibernation control function without modifying the program of the OS or the boot loader. As a result, the disclosed example can indeed effectively shorten the development time of the computer system.

Preferably, the awaking data 240 is a text file (such as a script file) or a binary file. If the awaking data 240 is the text file, the coprocessor 24 can first transform the text file into the binary file (such as complier or assembler). Then, the coprocessor 24 executes the awaking procedure according to the content of the transformed binary file.

In another embodiment of the disclosed example, the computer system 2 further comprises a trigger component 30 (such as the power button). The trigger component 30 is connected to the CPU 22, generates the hibernation trigger signal or the awaking trigger signal when the trigger component 30 receives an external operation, and transfers the generated hibernation trigger signal or the generated awaking trigger signal to the coprocessor 24. The trigger component 30 of this embodiment is connected to the CPU 22, but this specific example is not intended to limit the scope of the disclosed example. In another embodiment of the disclosed example, the trigger component 30 can be directly connected to the coprocessor 24, and can directly transfer the hibernation trigger signal or the awaking trigger signal to the coprocessor 24.

Please refer to FIG. 3, which illustrates aschematic view of a computer system according to a first embodiment of the present disclosed example. FIG. 3 is used to explain the setting way of each component of the computer system 2.

As shown in FIG. 3, in this embodiment, the JTAG connection port 20, the CPU 22, all of the coprocessor 24, the main memory 26 and the non-volatile memory 28 are installed on the PCB 32.

The computer system 2 further comprises a reader module 34. The reader module 34 installed on the PCB 32 is electrically connected to the CPU 22 via the PCB 32. In this embodiment, the reader module 34 is used to read an external memory 36. For example, the external memory 36 could be a Secure Digital card (SD card), the reader module 34 could be a card-reader. Preferably, the awaking data 240 is stored in the external memory 36.

Preferably, the R&D personnel can store the plurality of awaking data respectively corresponding to the CPUs respectively having the different types respectively in the plurality of different external memory 36. In other words, the awaking data 240 respectively stored in the external memory 36 is corresponded to one CPU having the corresponded type. When the CPU 22 of the computer system 2 is replaced, the R&D personnel only needs to insert the external memory 36 stored the awaking data 240 corresponding to the replacement CPU to the reader module 34. Thus, in the computer system 2 of this embodiment, the coprocessor 24 can retrieve the corresponded awaking data 240 and can achieve the fast booting function and the hibernation control function.

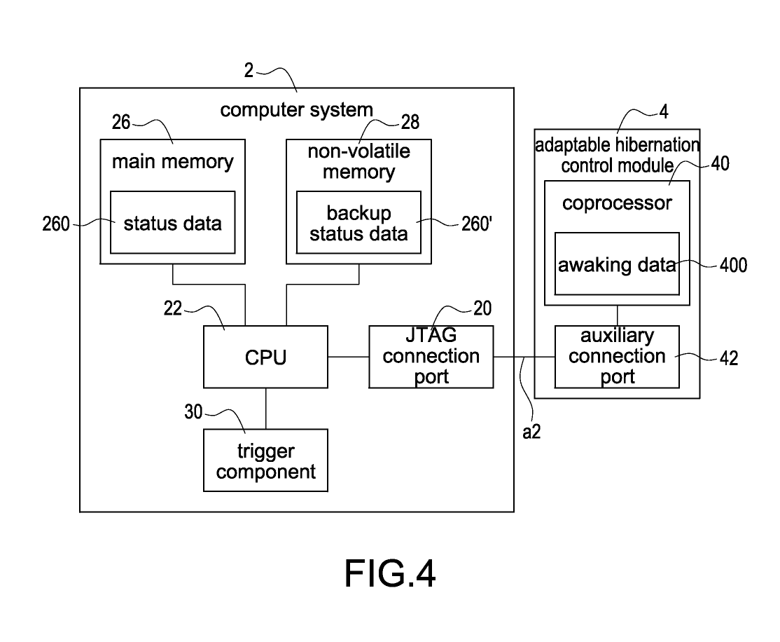

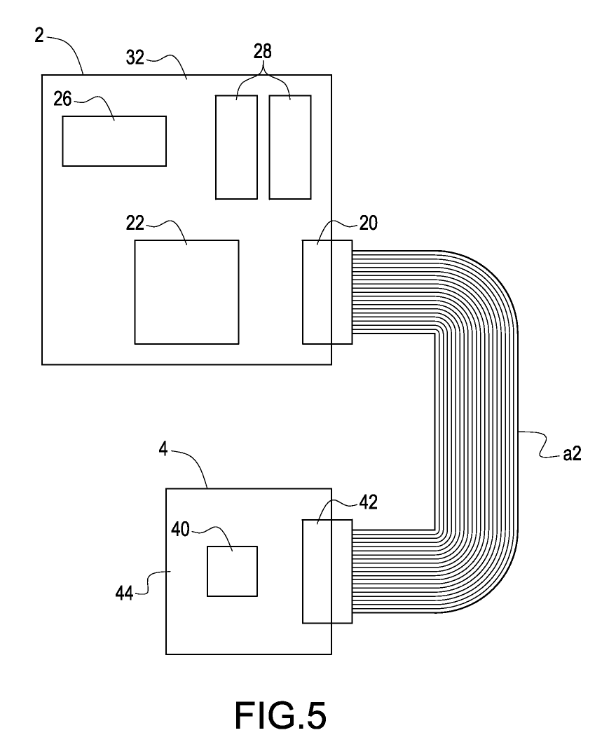

Please refer to FIG. 4 and also refer to FIG. 2 again. FIG. 4 illustrates an architecture diagram of an adaptable hibernation control module according to a first embodiment of the present disclosed example. As shown in FIG. 4, the adaptable hibernation control module 4 comprises a coprocessor 40 and an auxiliary connection port 42. The auxiliary connection port 42 is externally connected to the JTAG connection port 20 via a JTAG connection component a2. A memory of the coprocessor 40 stores an awaking data 400. Because the coprocessor 40 is not necessarily integrated with the computer system 2, this embodiment can effectively increase the flexibility of installation.

Please refer to FIG. 5, which illustrates a schematic view of an adaptable hibernation control module according to a first embodiment of the present disclosed example. As shown in FIG. 5, both the coprocessor 40 and the auxiliary connection port 42 are installed on the same auxiliary PCB 44. All the JTAG connection port 20, the CPU 22, the main memory 26 and the non-volatile memory 28 are installed on the same PCB 32. The auxiliary connection port 42 is connected to one end of the JTAG connection component a2, and the JTAG connection port 20 is connected to another end of the JTAG connection component a2.

Thus, the R&D personnel can achieve the fast booting function and the hibernation control function via the adaptable hibernation control module 4 without changing the original design of the PCM 32 of the computer system 2.

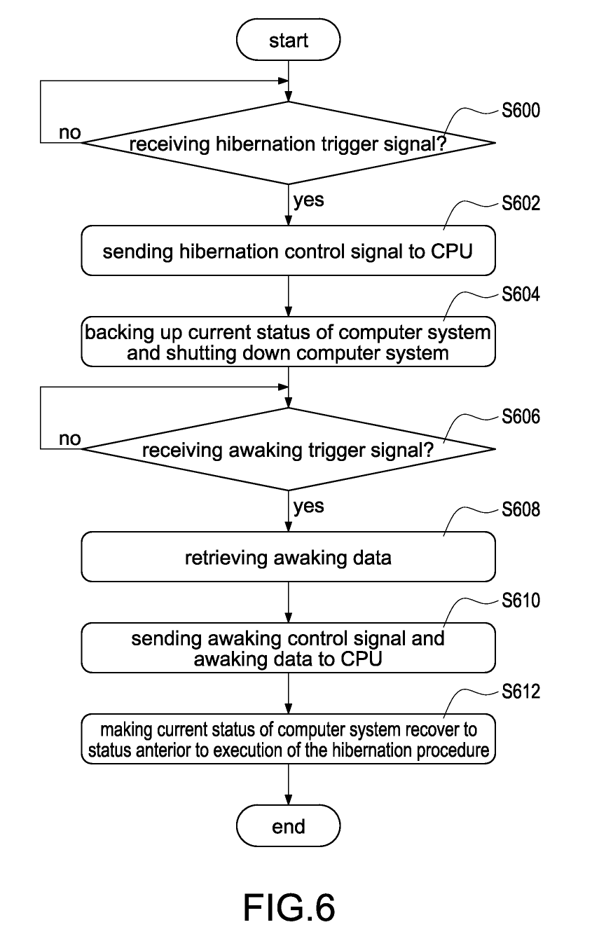

Please refer now to FIG. 6 and also refer to FIG. 2 and FIG. 4 again. FIG. 6 is a flowchart of an adaptable hibernation control method according to a first embodiment of the present disclosed example. The method of this embodiment comprises following steps.

Step S600: detect whether receiving the hibernation trigger signal. More specifically, the coprocessor 24 detects whether the coprocessor 24 receives the hibernation trigger signal from the trigger component 30. If the coprocessor 24 receives the hibernation trigger signal, the coprocessor 24 performs the step S602. Otherwise, the step S600 is repeatedly performed to continuously detect whether the coprocessor 24 receives the hibernation trigger signal.

Step S602: send the hibernation control signal to the CPU 2. More specifically, the coprocessor 24 sends the hibernation control signal to the CPU 22 of the computer system 2 via the JTAG connection component al and the JTAG connection port 20 for executing the hibernation procedure via controlling the CPU 22.

Step S604: back up the current status of the computer system 2 and shut down the computer system 2. More specifically, the CPU 22 backs up the current status of the computer system 2 according to the received hibernation control signal, and shuts down the computer system 2 to make the computer system 2 enter the hibernation mode.

Step S606: detect whether receiving the awaking trigger signal. More specifically, the coprocessor 24 detects whether the coprocessor 24 receives the awaking trigger signal from the trigger component 30. If the coprocessor 24 receives the awaking trigger signal, the coprocessor 24 performs the step S608 for making the computer system 2 leave the hibernation mode. Otherwise, the step S606 is repeatedly performed to continuously detect whether the coprocessor 24 receives the awaking trigger signal.

Step S608: retrieve the awaking data 240.

Step S610: send the awaking control signal and the awaking data 240 to the CPU 22. More specifically, the coprocessor 24 sends the awaking control signal and the awaking data 240 to the CPU 22 of the computer system 2 via the JTAG connection component al and the JTAG connection port 20 for executing the awaking procedure via controlling the CPU 22.

Step S612: make the current status of the computer system 2 recover to the status anterior to the execution of the hibernation procedure. More specifically, the CPU 22 makes the current status of the CPU 22 recover to the status anterior to the execution of the hibernation procedure (anterior to the performance of the step S602) according to the received awaking control signal and the received awaking data 240. Thus, the computer system 2 can leaves the hibernation mode and can achieve the fast booting function.

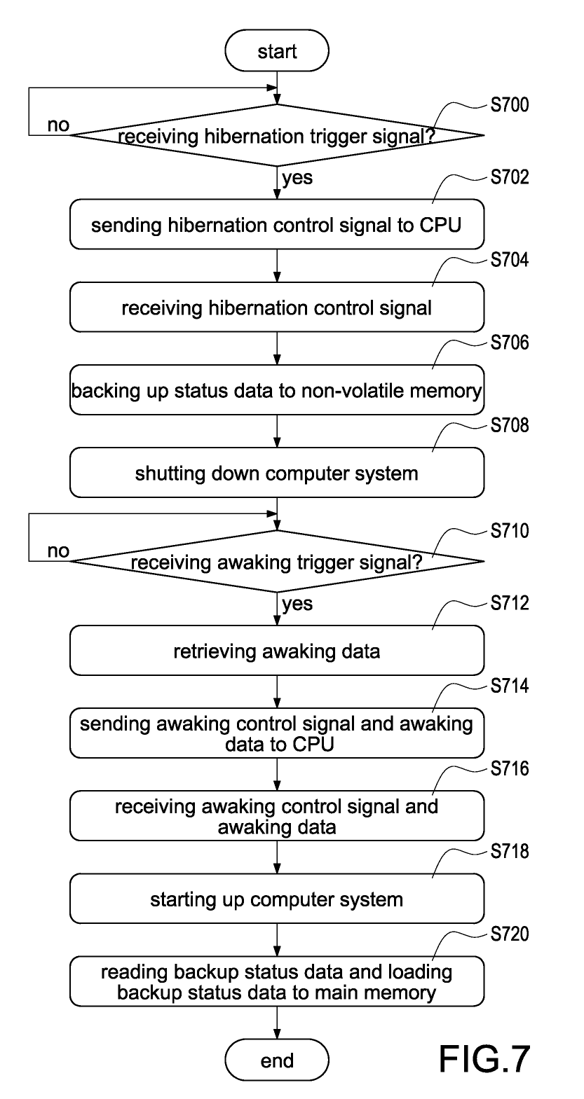

Please refer to FIG. 2, FIG. 4 and FIG. 7. FIG. 7 is a flowchart of an adaptable hibernation control method according to a second embodiment of the present disclosed example. The method of this embodiment comprises following steps.

Step S700: detect whether receiving the hibernation trigger signal. If the coprocessor 24 receives the hibernation trigger signal, the coprocessor 24 performs the step S702. Otherwise, the step S700 is repeatedly performed to continuously detect whether the coprocessor 24 receives the hibernation trigger signal.

Step S702: sends the hibernation control signal to the CPU 22.

Step S704: the CPU 22 receives the hibernation control signal.

Step S706: back up the status data 206 to the non-volatile memory 28. More specifically, the CPU 22 backs up the status data 206 stored in the access data address of the main memory 26 to the mapping address of the non-volatile memory 28 as the backup status data 260′ according to the control of the coprocessor 24 (In other words, the content of the hibernation control signal.).

Step S708: shut down the computer system 2. More specifically, the CPU 22 shuts down the computer system 2 according to the received hibernation control signal for making the computer system 2 enter the hibernation mode.

Step S710: detect whether receiving the awaking trigger signal. If the coprocessor 24 receives the awaking trigger signal, the coprocessor 24 performs the step S712. Otherwise, the step S710 is repeatedly performed to continuously detect whether the coprocessor 24 receives the awaking trigger signal.

Step S712: retrieve the awaking data 240.

Step S714: send the awaking control signal and the awaking data 240 to the CPU 22.

Step S716: the CPU 22 receives the awaking control signal and the awaking data 240.

Step S718: start up the computer system 2. More specifically, the awaking data 240 comprises the register data address corresponding to the CPU 22. The CPU 22 recovers to properly operate according to the received awaking control signal and the register data address, and makes the other device of the computer system 2 recover to normally operate according to the received awaking control signal.

Step S720: read the backup status data 260′ and load the backup status data 260′ to the main memory 26. More specifically, the awaking data 240 further comprises the access data address of the main memory 26 and the mapping address of the non-volatile memory. The CPU 22 reads the backup status data 260′ from the mapping address of the non-volatile memory 28 according to the awaking control signal and the awaking data 240, and loads the backup status data 260′ to the access address of the main memory 26 as the status data 260. Thus, the computer system 2 can leave the hibernation mode and can achieve the fast booting function.

The present disclosed example can achieve the fast booting function via using the coprocessor to replace the CPU to execute the hibernation procedure and the awaking procedure. And the present disclosed example can make the fast booting function applicable to the CPUs having different types without modifying the OS or the boot loader of the computer system.

In other words, the present disclosed example can make the CPUs having different types achieve the fast booting function via the coprocessor without modifying the OS or the boot loader according to the type of the CPU. Thus, the development time can be effectively shortened.

The foregoing descriptions of embodiments of the disclosed example have been presented only for purposes of illustration and description. They are not intended to be exhaustive or to limit the disclosed example to the forms disclosed. Accordingly, many modifications and variations will be apparent to practitioners skilled in the art. Additionally, the above disclosure is not intended to limit the disclosed example. The scope of the disclosed example is defined by the appended.

What is claimed is:

1. A computer system, comprising:
a JTAG (Joint Test Action Group) connection port;
a CPU electrically connected to the JTAG connection port; and
a coprocessor connected to the JTAG connection port comprising an awaking data corresponding to the CPU;
wherein the coprocessor sends a hibernation control signal to the CPU to execute a hibernation procedure via controlling the CPU when receive a hibernation trigger signal; the hibernation procedure comprises backing up a current status data of the computer system and shutting down the computer system; the coprocessor sends an awaking control signal and an awaking data to the CPU to execute an awaking procedure according to the awaking data via controlling the CPU when receive an awaking trigger signal; the awaking procedure comprises making the current status of the computer system recover to a status anterior to the execution of the hibernation procedure.

2. The computer system of claim 1, further comprising:
a main memory electrically connected to the CPU storing the status data; and
a non-volatile memory electrically connected to the CPU;
wherein the coprocessor backs up the status data to the non-volatile memory as a backup status data when execute the hibernation procedure, and reads the backup status data from the non-volatile memory and loads the backup status data to the main memory as the status data according to the awaking data when execute the awaking procedure.

3. The computer system of claim 2, wherein the awaking data comprises a register data address corresponding to the CPU, an access data address of the main memory and a mapping address of the non-volatile memory, wherein the mapping address is corresponded to the access data address.

4. The computer system of claim 3, wherein the coprocessor makes the CPU operate, start up the computer system, read the backup status data from the mapping address of the non-volatile memory, and load the backup status data to the access data address of the main memory according to the register data address during executing the awaking procedure.

5. The computer system of claim 3, wherein the awaking data is a script file or a binary file; the awaking data is stored in a memory of the coprocessor, the non-volatile memory or an external memory connected to the CPU.

6. The computer system of claim 1, wherein the JTAG connection port is connected to one end of a JTAG connection component, the coprocessor is connected to another end of the JTAG connection component; the CPU supports the JTAG technology.

7. The computer system of claim 1, further comprising:
a trigger component connected to the CPU or the coprocessor, the trigger component generates the hibernation trigger signal or the awaking trigger signal when receive an external operation.

8. An adaptable hibernation control module, comprising:
an auxiliary connection port connected to a JTAG connection port of a computer system via a JTAG connection component, wherein the JTAG connection port is electrically connected to a CPU of the computer system; and
a coprocessor electrically connected to the auxiliary connection port comprising an awaking data corresponding to the CPU;
wherein the coprocessor sends a hibernation control signal to the CPU to execute a hibernation procedure via controlling the CPU when receive a hibernation trigger signal; the hibernation procedure comprises backing up a current status data of the computer system and shutting down the computer system; the coprocessor sends an awaking control signal and an awaking data to the CPU to execute an awaking procedure according to the awaking data via controlling the CPU when receive an awaking trigger signal; the awaking data procedure comprises making the current status of the computer system recover to a status anterior to the execution of the hibernation procedure.

9. An adaptable hibernation control method, comprising:
a) a coprocessor sending a hibernation control signal to a CPU of a computer system to execute a hibernation procedure via controlling the CPU when receive a hibernation trigger signal;
b) the CPU backing up a current status of the computer system and shutting down the computer system according to the hibernation control signal;
c) the coprocessor retrieving an awaking data corresponding to the CPU of the computer system when receive an awaking trigger signal;
d) sending an awaking control signal and the retrieved awaking data to the CPU to execute an awaking procedure according to the awaking data via controlling the CPU; and
e) the CPU making the current status of the computer system recover to a status anterior to the execution of the hibernation procedure.

10. The adaptable hibernation control method of claim 9, wherein the step b) comprises:
b1) receiving the hibernation control signal;
b2) backing up a status data stored in the computer system to a non-volatile memory as a backup status data according to the hibernation control signal; and
b3) shutting down the computer system according to the hibernation control signal.

11. The adaptable hibernation control method of claim 10, wherein the step e) comprises:
e1) receiving the awaking control signal and the awaking data;
e2) starting up the computer system according to the awaking control signal and the awaking data; and
e3) reading the backup status data from the non-volatile memory and loading the backup status data to a main memory of the computer system as the status data according to the awaking control signal and the awaking data.

12. The adaptable hibernation control method of claim 11, wherein the awaking data comprises a register data address corresponding to the CPU; the step e2) is to make the CPU operate and to start up the computer system according to the register data address.

13. The adaptable hibernation control method of claim 11, wherein the awaking data comprises a access data address of the main memory and a mapping address of the non-volatile memory; the mapping address is corresponded to the access data address; the step e3) is to read the backup status data from the mapping address of the non-volatile memory and to load the backup status data to the access data address of the main memory.

14. The adaptable hibernation control method of claim 9, wherein the awaking data is a script file or a binary file.
